(19) United States
(12) Patent Application Publication
(10) Pub. No.: US 2014/0203101 A1
(43) Pub. Date: Jul. 24, 2014

(54) Water Shooter Device and Associated Visual Water Effects

(71) Applicants: Mark Fuller, Sun Valley, CA (US); Jim Doyle, Sun Valley, CA (US); Eric Galpin, Sun Valley, CA (US); Don Lariviere, Sun Valley, CA (US)

(72) Inventors: Mark Fuller, Sun Valley, CA (US); Jim Doyle, Sun Valley, CA (US); Eric Galpin, Sun Valley, CA (US); Don Lariviere, Sun Valley, CA (US)

(21) Appl. No.: 14/134,983

(22) Filed: Dec. 19, 2013

Related U.S. Application Data
(60) Provisional application No. 61/739,667, filed on Dec. 19, 2012.

(51) Int. Cl. B05B 17/08

(52) U.S. Cl. CPC B05B 17/08
USPC 239/16

(57) ABSTRACT

A device to shoot water into the air for a water display is described. The configuration of the shooter allows a stream of water to be shot out that contains reduced or no air exiting the device with the water, which provides a non-frothy appearance. The device may control the velocity of the water being shot by the device so that unique visual effects may be achieved, including an effect where a volume of water is suspended in the air.

### CROSS REFERENCE TO RELATED APPLICATION

The application claims the benefit of U.S. Provisional Application No. 61/739,667, filed Dec. 19, 2012, the contents of which are incorporated herein by reference.

### FIELD OF THE INVENTION

The present invention relates generally to water displays and devices that provide the visual effects that appear in the display, including devices that may provide a stream of water with reduced air or frothiness and/or devices that provide unique visual effects, such as a volume of water that may resemble a jellyfish above the ground.

### BACKGROUND OF THE INVENTION

Various water displays and devices that provide visual water effects currently exist. Oftentimes, a visual effect is produced by shooting a stream of water into the air by forcing the water out of a container with air pressure. That is, air is fed into the container which pushes the water out of a nozzle. With this type of configuration, a large amount of air may exit the nozzle with the air, thereby giving the stream of water a frothy appearance. This type of appearance would not work for visual effects intended to have a smooth watery appearance without the air bubbles that typically exist in a frothy stream of water.

Certain existing devices that shoot a stream of water into the air may also not control the velocity of the water exiting the nozzle of the device. This generally limits the type of visual effects that may be provided by that device. For example, if the velocity profile of the water is not maintained sufficiently high, water that exits the nozzle later in time may never travel significantly off the ground. In this situation, the visual water effect provided by the device may remain “attached” to the ground. This visual effect where the water remains “attached” to the ground will also occur if the device shooting out the water cannot shut off the stream of water quickly enough at the end of the shot.

Accordingly, there is a need in the field of water displays for a device that may provide a stream of water that contains reduced air, that may control the velocity profile of water exiting the device and/or that provides new and unique visual effects, including effects where a volume of water is completely separated from the ground and may assume particular shapes. These and other issues are addressed by the current invention described herein.

### SUMMARY OF THE INVENTION

In an aspect of the invention, a device that may provide a non-frothy stream, or stream of reduced frothiness, of water into the air is described. To this end, the device provides that air used to shoot the stream of water out of the device is sufficiently separated from the intake of the tube leading to the exit nozzle. In this manner, air does not mix with water as it is ejected from the device for a longer time than might otherwise occur.

In another aspect of the invention, a device that may control the velocity profile of a water stream it shoots out is described.

In another aspect of the invention, a visual water effect that may simulate the appearance of a water canopy, jellyfish and/or blob that may be achieved by the device of the current invention is described. The water effect may be achieved by controlling the velocity profile of the water stream and/or by providing that the water forming the stream is not frothy with significant air mixed in. This visual water effect may be separated from the ground by varying distances thereby giving the appearance of being suspended in mid-air.

### BRIEF DESCRIPTION OF THE DRAWINGS

FIG. 1 is a perspective view of a device for shooting water into the air.

FIG. 2 is a section view of the device of FIG. 1.

FIGS. 3-9 show a stream of water shot out of the device of FIG. 1 to provide a visual water effect. FIGS. 3-9 show the stream of water as it appears over time.

### DETAILED DESCRIPTION OF THE PREFERRED EMBODIMENTS

The water shooter device 10 of the current invention and visual water effects that it may produce are now described with reference to the figures. Where the same or similar components appear in more than one figure, they are identified by the same reference numeral. The invention is described herein with reference to water. However, other liquids and combinations thereof are within the scope of the invention.

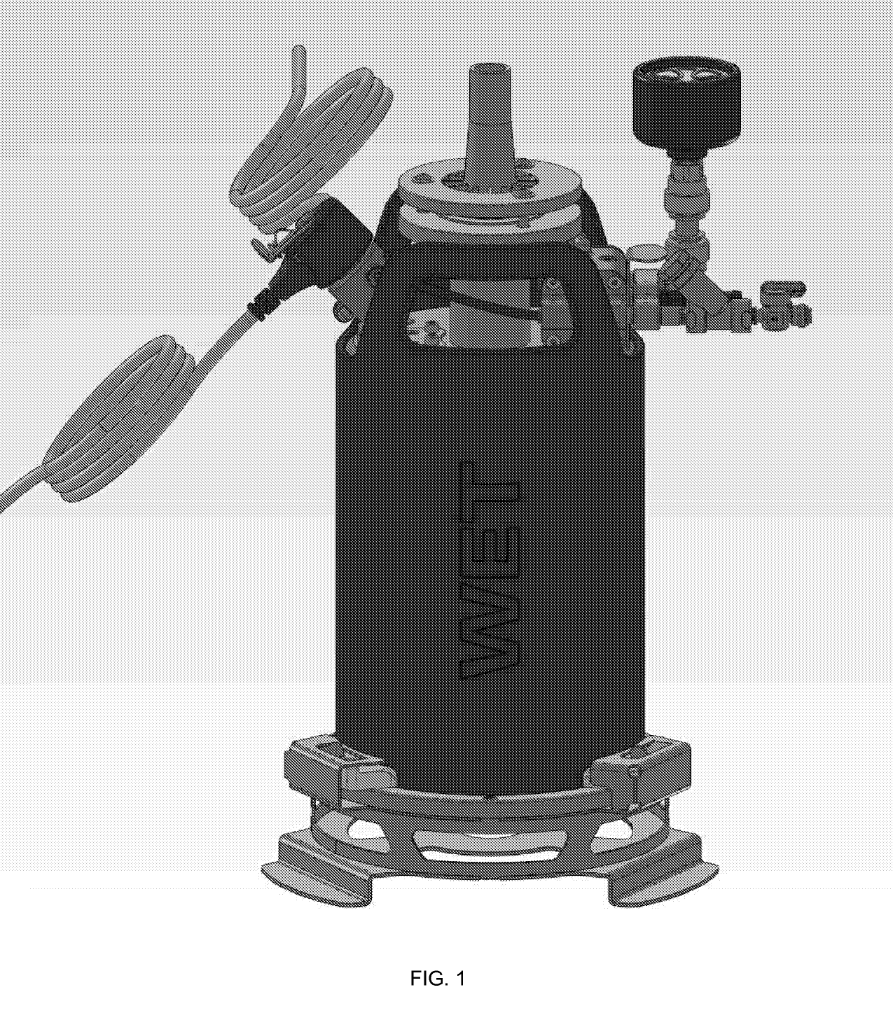

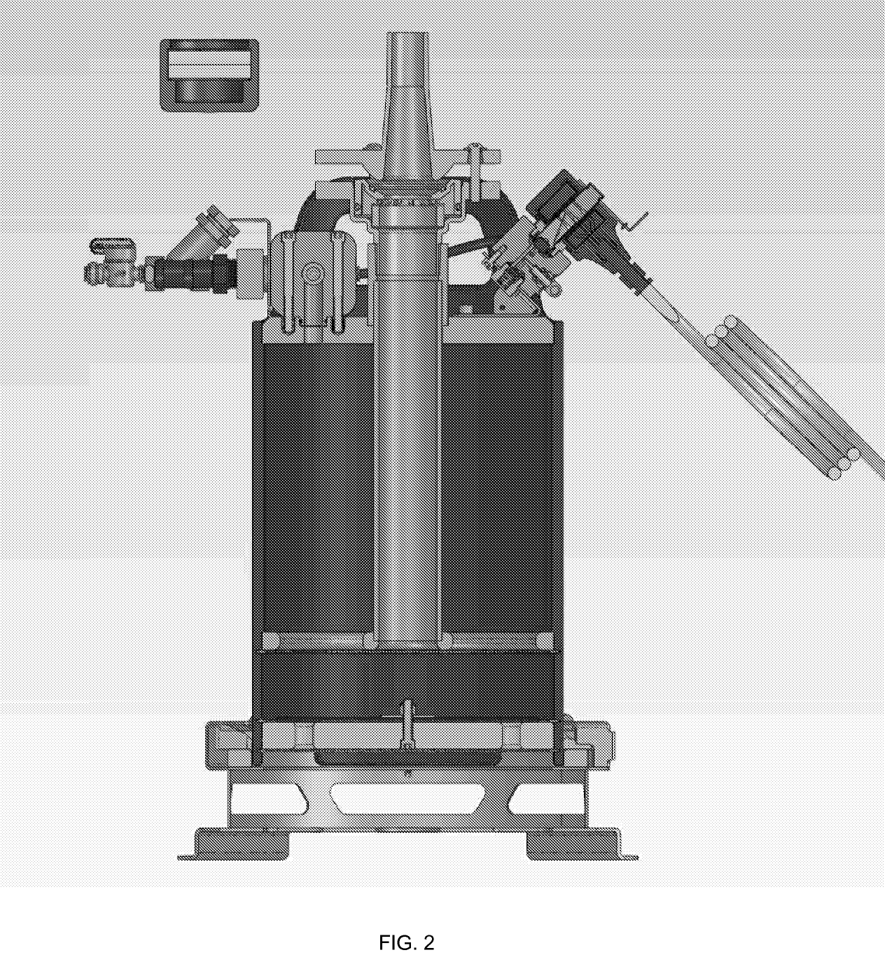

FIG. 1 is a perspective view of canopy or water shooter 10 while FIG. 2 is a sectional view thereof which shows more detail regarding internal components. Water shooter 10 may include various components such as main chamber 20 which may contain a volume of water. The size of main chamber 20 may vary depending on factors such as the amount of water 30 to be shot out and the velocity at which it exits device 10.

Shooter 10 may also include air valve 40 that may release air into main chamber 20 so as to force water 30 out of device 10. Air valve 40 may include outlet 42 which serves to deliver air into chamber 20. Air may be delivered to valve 40 from an air reservoir (not shown) that may be pressurized so that air flows into chamber 20 and forces water 30 out. Pilot valve 50 may trigger air valve 40 and regulate the amount of air fed into main chamber 20.

Exit nozzle 60 may generally serve as the conduit through which water 30 is received from chamber 20 and shot out of shooter 10. More specifically, nozzle 60 may include nozzle extension 62 extending axially along a length of main chamber 20 down to near the bottom 22 of main chamber 20. The bottom of nozzle extension 62 may comprise intake 64 through which water 30 is forced when air valve 40 releases air into main chamber 20. More particularly, when air is released into main chamber 20, it pushes water 30 surrounding nozzle extension 62 downward. This forces water 30 into intake 64, through nozzle extension and up to nozzle outlet 66 where it exits shooter 10 and is shot into the air.

An aspect of the current invention relates to the production of a non-frothy stream of water or a stream of water having reduced frothiness. It should be noted that the current invention is not limited to the situation involving a stream of water having no frothiness whatsoever. Indeed, device 10 of the current invention may provide stream of water with reduced air mixed in. Accordingly, use of the term non-frothy does not necessarily mean a stream with no air. However, water streams with reduced or significantly reduced air mixture are within the scope of the invention.

The configuration and location of air valve 40 facilitates this aspect of the current invention. To this end, air valve 40 may be located at or near the top 24 of chamber 20. As such, air is released into chamber 20 at or near its top 24. When considering that a significant volume of water may exist between air valve 40 and the intake 64 of nozzle extension 62, the water 30 that is shot out of device 10 is generally not combined with air. That is, a significant volume of water would need to be forced out of chamber 20 before significant air would reach intake 64 to mix in with exiting water. This provides for a non-frothy stream of water shooting out of exit nozzle 66, or a stream of water having reduced frothiness.

The configuration and location of nozzle 60 may also relate to this aspect of the invention. To this end, nozzle extension 62 may extend to near the bottom 22 of chamber 24 so that intake 64 is some distance away from air valve 40. As mentioned above, a significant amount of water may thus need to be ejected from device 10 before any significant amount of air would come near intake 64. This again provides for a non-frothy stream of water, or a stream of water having reduced frothiness.

The length and position of nozzle extension 62 may be related to the duration of intended water shots. To this end, nozzle extension 62 is preferably long enough, and extends sufficiently near the bottom 22 of chamber 20, compared to the duration of the shot, so that level of water 30 does not fall below the level of intake 64. In this manner, air is generally not released with water 30 and a non-frothy appearance is achieved.

The non-frothy effect may also be facilitated by a combination of the two foregoing aspects. That is, air valve 40 may be located at or near the top 24 of chamber 20 and intake 64 of nozzle extension 62 may be located at or near the bottom 22 of chamber 20. This results in a significant amount of water having to be shot out of chamber 20 before any significant air enters intake 64.

Air valve 40 and/or intake 64 are preferably located so that the desired volume of water 30 may be shot out of device 10, for the desired amount of time, prior to significant air mixing. In other words, if a water shot of about five seconds is desired, air valve 40 and/or intake 64 are preferably positioned so that air does not reach intake 64 in that amount of time.

The foregoing description is in contrast to past shooters which introduce air at the bottom of the shooter body. This configuration allows air and water to be readily combined as the combination is forced out of the exit nozzle. Because significant air may be ejected with water, these past shooters produce a stream of water having a much frothier appearance.

Another aspect of the current invention relates to controlling the velocity at which water 30 exits nozzle 66 over time, or its velocity profile. It will be appreciated that if the velocity of water exiting the shooter slows down over the course of a shot, the later ejected water will not be shot up into the air as high as previously shot water. In this case, the overall shot of water will not appear to be distanced from the ground. This is because the later shot water will simply not get off the ground all that much and may appear “attached” to the ground.

With the current invention, however, shooter device 10 may achieve a relatively constant velocity profile of water leaving nozzle 66 for the duration of the shot. This may be accomplished by the current invention in several ways. For example, device 10 may work with a relatively large air reservoir (not shown) when compared to the size of main chamber 20 in shooter 10. This provides for significant air pressure that does not appreciably drop over the time that water 30 is shot out of device 10. This in turn provides that water 20 may exit nozzle 66 at a generally constant velocity during the shot.

In this manner, and as more fully described below, if the water is shut off after some amount of time, the later shot water will still travel about as high off the ground as earlier shot water (since they all left nozzle 66 at about the same velocity). In this scenario, the water may appear suspended in mid-air some distance off the ground prior to gravity causing the water to fall to the ground. This suspension effect may occur, in part, because the earlier shot water encounters the later shot water as gravity starts to pull down the earlier shot water. This interaction may serve to suspend the earlier shot water above the ground for longer than it otherwise would have been. In any event, this provides a unique visual effect.

Maintaining the velocity profile of the water being shot out of shooter 10 is in contrast to current shooters where air pressure may appreciably fall during the course of a shot. This may occur where an air reservoir tank is used that is relatively small or not large when compared to the size of the volume of water contained by the shooter. In these types of existing shooters, air pressure will drop over the course of the shot and water that leaves the shooter later will exit the nozzle at a slower velocity and will not travel off the ground as far as water that was shot earlier.

Another reason that existing shooters are unable to achieve the suspended water effect where the water is not “attached” to the ground is because these existing shooters use pumps to drive the water. Pumps generally cannot be shut off crisply enough, so the turning-off portion of the shot is too extended. This allows the water to slow down when the pump goes from full-on to full-off. This in turn loses the effect of a water element being detached from the ground. With the shooter 10 of the current invention, the velocity profile remains constant until the water is gone, or well below the inlet, and then it is suddenly off (since no more water comes out).

It should be noted that maintaining the velocity profile of the water as it leaves shooter 10 over the course of the shot is not solely dependent on the use of an air reservoir that is large in relation to main chamber 20. Instead, the current invention includes other manners in which the water velocity profile may be maintained.

For example, if the nozzle extension 62 and/or the shot duration are such that no air is released with the water, then the pressure driving the water shot does not change appreciably during the duration of the shot. This may also result in a substantially constant water velocity profile that is not solely dependent on the size of any air reservoir. As another example, a substantially constant water velocity profile may be achieved by a combination of these three factors, i.e., the relative size of the air reservoir compared to the volume of main chamber 20, the length of nozzle extension 62 so that a sufficiently large volume of water initially exists between air valve 40 and intake 64 and the duration of the shot.

The current invention may be practiced with one or both of the above-described inventive aspects, i.e., non-frothy water shot and/or constant velocity profile. Accordingly, existing shooters where the velocity profile changes may still be used with the inventive aspect relating to non-frothy appearance. Similarly, existing shooters providing a frothy appearance may be used with the inventive aspect relating to constant velocity profile. Alternatively, water may be shot from shooter 10 in a non-frothy manner and while maintaining constant velocity profile.

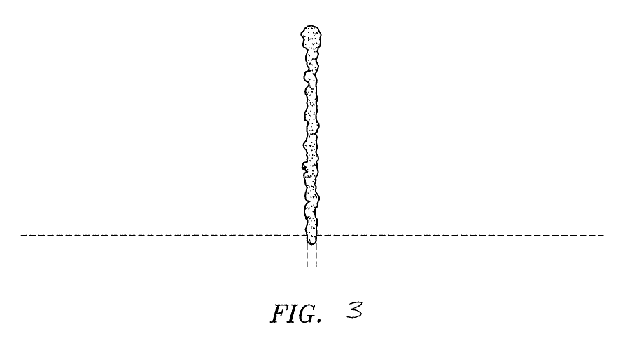

Dramatic visual water effects that may be achieved with the above-described inventive aspects are now described with reference to FIGS. 3-9. These figures sequentially show a shot of water over time where the velocity profile remains substantially the same over the duration of the water shot. The water in these figures also has a non-frothy appearance.

Given that the velocity of the water as it is ejected does not change during the duration of the shot, water coming out at the end of the shot goes approximately as high as water that came out at the beginning of the shot, and all water may collide near the apex of the shot. Also, at some point in time during the shot, the stream of water is disconnected from the shooter. As discussed below, this may provide a jellyfish effect.

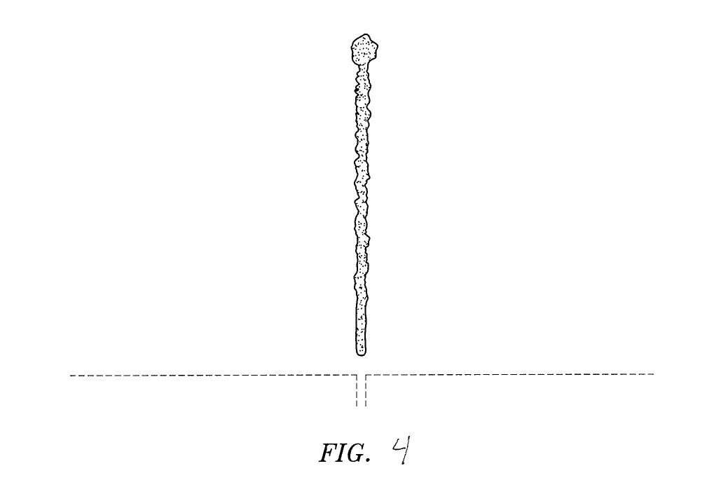

FIG. 3 shows a stream of water at the beginning of a water shot. At this point, the water may be extending up generally vertically. Some time later during the shot, FIG. 4 shows how water that left nozzle 66 later in time continues to travel upward, but at the same time, earlier released water starts experiencing the effects of gravity. The appearance of water starting to gather at the top of the shot is caused because the later released water meets the earlier released water at or near the apex of the shot.

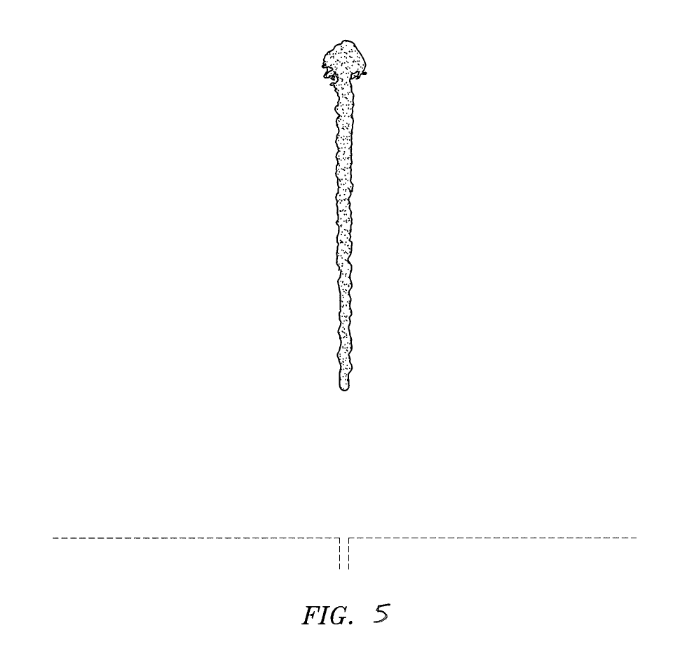

FIG. 5 shows the water shot a little later in time where the previously shot water continues to experience the effects of gravity but later released water continues to meet the earlier released water at or near the shot's apex. In this manner the visual effect of gathering water increases.

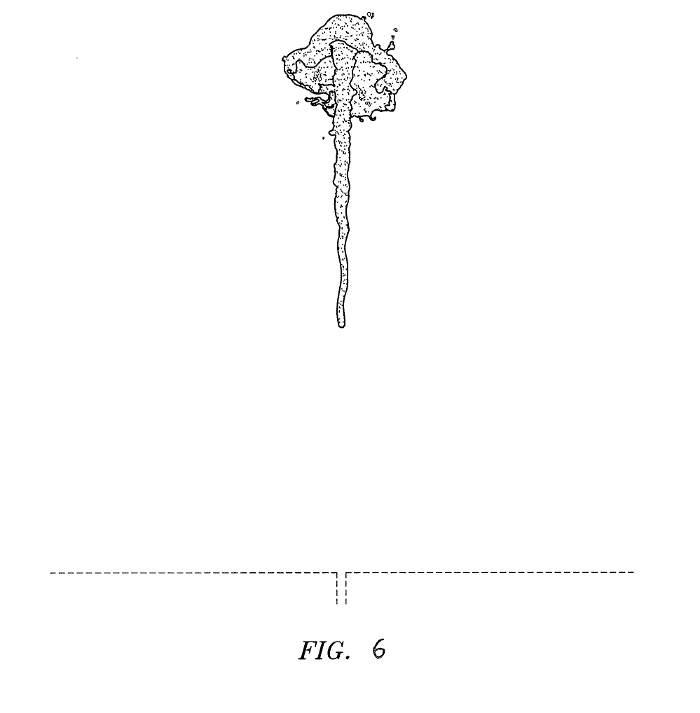

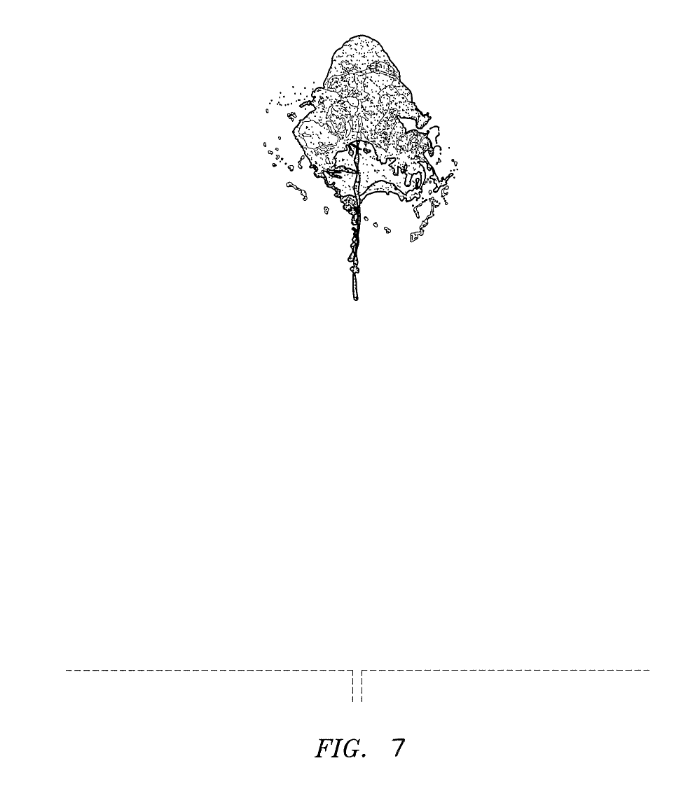

After enough time has gone by during the shot, enough water collects at or near the apex of the shot such that it begins to fan out to provide a canopy-like appearance as shown in FIG. 6. This effect continues over time as shown in FIGS. 7-9 since later released water continues to meet earlier released water. During this time, the water shot increasingly resembles a jellyfish, or a type of blob.

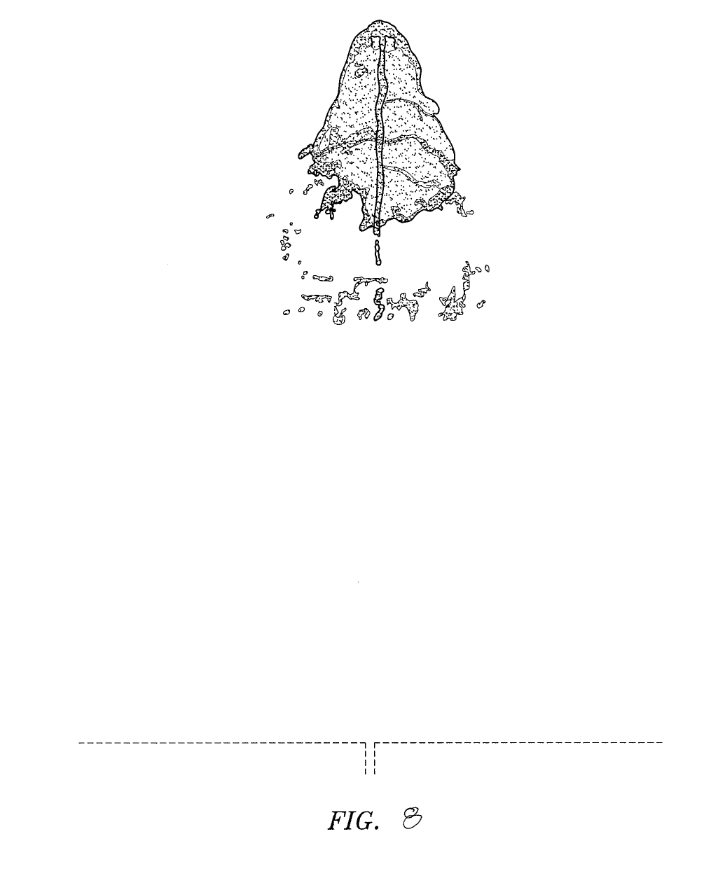

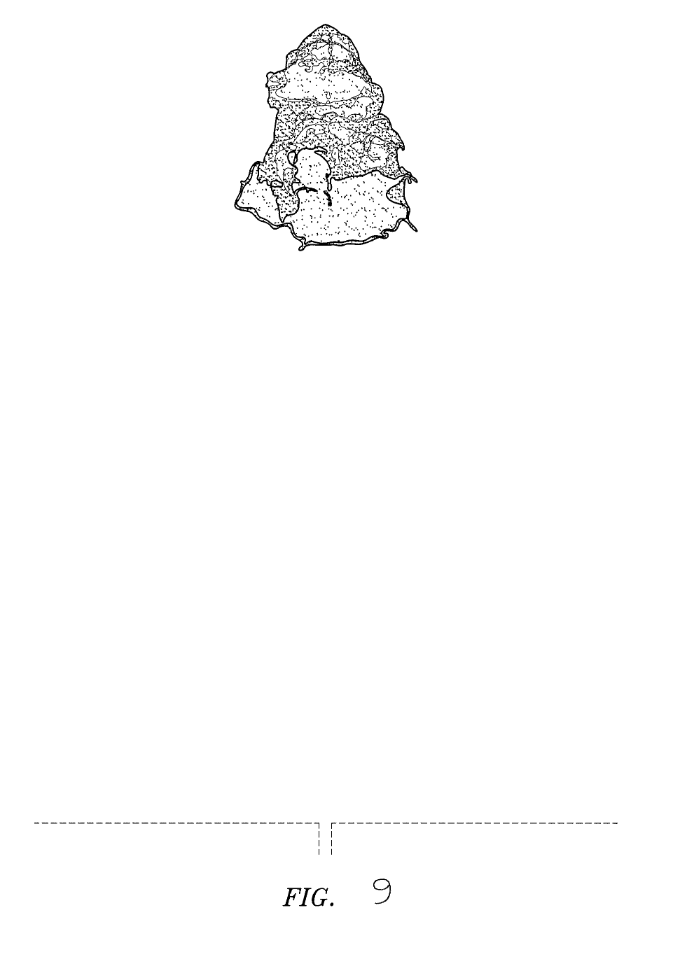

Near the end of the water shot, the stream of water from shooter 10 may be turned off. In this manner, the last released water will shoot upward, but because there is no more water being released, a distance between the water shot and shooter (or ground) will be created and will increase. The appearance of this mid-air suspension is shown in FIGS. 8 and 9, where water is no longer being shot up, and the water that has by now been experiencing the effects of gravity, has not yet fallen down.

Preferably, shooter 10 of the current invention includes a mechanism that shuts off the stream of water quickly and definitively so that the water stream abruptly stops. This preferably creates a gap between the shooter and the last released water, which gap increases as the last released water travels upward. In any event, the delay in water falling down may be facilitated by the later and last released water continuing to meet the falling water at or near the shot's apex.

As shown in FIG. 9, the jellyfish, or blob, of water may generally exist for a moment in time. Because there has been no water shooting up for some amount of time, and because the shut-off valve is quick and abrupt, this form may generally appear suspended in mid-air. Thereafter, gravity takes over and the jellyfish, or blob, will generally return to the ground.

The distance between the jellyfish (blob) and shooter 10 (or ground) may be relatively large. For example, shooter 10 may produce a gap anywhere from 6 to 20 feet depending on how the pressure of air valve 40 is set. To this end, the pressure may be set differently for different shows or parts of the same show. In other words, shooter 10 may provide that the observer may see a jellyfish shaped blob of water up in the air isolated from the ground.

Beyond the foregoing, the appearance of this effect may be enhanced by lighting at night. To this end, the jellyfish produced by shooter 10 may be lighted to different colors.

This is in sharp contrast to other existing fountain shooters that do not provide for a stream disconnect between the shooter and the released water. This is because existing shooters cannot shut off the water stream fast enough with the mechanism employed to do so. Consequently, the observer would not see a blob of water in mid-air; instead, the observer would just see a continuous stream from bottom to top. Also, since the water never congregates in one place with certain existing shooters, the water does not produce as pronounced of a blob at or near the apex of the water shot.

The visual water effect described above would generally not be possible with certain existing shooters. For example, where an existing shooter is configured to work with a volume of compressed air that is smaller compared to the body of the shooter, e.g., the volume of compressed air is generally the same as the volume of the shooter body, then as the shot progresses the pressure driving the water out of the shooter will drop significantly. The equation governing this is P=Pᵢₙᵢₜᵢₐₗ(V/Vᵢₙᵢₜᵢₐₗ)^{-1.4}.

Consequently the water coming out towards the end of the shot does not go as fast, nor as high, as the water ejected at the beginning of the shot. The totality of water does not meet at or near the apex of the shot as described above since water ejected later in the shot does not go as high as water ejected at the beginning of the shot. Accordingly, the jellyfish effect is significantly reduced or does not occur at all.

Along with the above, or instead of, the water velocity profile need not be maintained during the duration of the shot due to, for example, the length of nozzle extension 64 compared to the length of the shot duration. If nozzle extension 64 is short, and the duration of the shot long enough, then air will be ejected with the water and this will produce a frothy effect. In addition, if the air reservoir is not big enough, it will cause the air pressure to drop noticeably (due to the loss of air out the nozzle) and so the velocity of the water will decrease during the course of the shot.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water shooter device, comprising:
a chamber containing water;
an air valve located near the top of the chamber to deliver air to the chamber; and
a nozzle extending for at least part of the length of the chamber and having a water intake;
wherein the nozzle receives water that is forced through the water intake by the delivered air, and ejects the water upward for a duration; and
wherein the delivered air does not reach nozzle intake for the duration.

2. The water shooting device of claim 1, wherein the water ejected upward has a non-frothy appearance.

3. The water shooting device of claim 1, wherein the water ejected upward has a substantially constant velocity profile.
